(19) United States
(12) Patent Application Publication
(10) Pub. No.: US 2017/0175619 A1
(43) Pub. Date: Jun. 22, 2017

(54) EXHAUST SOOT UTILIZED FOR EXTENDING THE LIFE OF A WASTEGATE

(71) Applicant: BorgWarner Inc., Auburn Hills, MI (US)

(72) Inventors: SEAN HASTINGS, ARDEN, NC (US); JONATHAN WILLIAMS, FLETCHER, NC (US); JOSHUA NORSWORTHY, ASHEVILLE, NC (US)

(21) Appl. No.: 14/976,264

(22) Filed: Dec. 21, 2015

(51) Int. Cl. F02B 37/18; F01D 25/16; F01D 17/14; F01D 25/18; F01D 25/24; F01D 25/32

(52) U.S. Cl. CPC F02B 37/186; F01D 25/24; F01D 25/32; F01D 17/145; F01D 25/18; F01D 25/16; F05D 2220/40; F05D 2240/63

(57) ABSTRACT

A number of variations may include providing a turbine housing including a wastegate valve including a shaft, a bushing, and a clearance disposed there between; the turbine housing furthering including a soot collector and a soot accelerator constructed and arranged to facilitate the flow of soot laden exhaust gas to the clearance. The method may further include collecting exhaust gas including soot via the soot collector; and providing soot within the clearance to lubricate the shaft and the bushing.

### TECHNICAL FIELD

The field to which the disclosure generally relates includes turbocharger lubrication and wear reduction.

### BACKGROUND

Wastegate applications experience wear due to repeated cycling at partially open conditions. Wastegates that are subject to modulation require wear reducing solutions to increase life expectancy. Diesel combustions exhaust may include soot which may include graphite. Utilizing exhaust soot may be utilized to lubricate a wastegate bushing and shaft.

### SUMMARY OF ILLUSTRATIVE VARIATIONS

A number of variations may include a product including a turbine housing including a wastegate valve comprising a shaft, a bushing, and a clearance disposed there between; the turbine housing furthering including at least one of a soot collector or a soot accelerator constructed and arranged to facilitate the flow of soot laden exhaust gas to the clearance.

A number of variations may include providing a turbine housing including a wastegate valve including a shaft, a bushing, and a clearance disposed there between; the turbine housing furthering including a soot collector and a soot accelerator constructed and arranged to facilitate the flow of soot laden exhaust gas to the clearance. The method may further include collecting exhaust gas including soot via the soot collector; and providing soot within the clearance to lubricate the shaft and the bushing.

A number of variations may include providing a turbine housing may include a wastegate valve may include a shaft, a bushing, and a clearance disposed there between; the turbine housing furthering may include a soot collector and a soot accelerator constructed and arranged to facilitate the flow of soot laden exhaust gas to the clearance; wherein the shaft may include a surface feature defined on a surface of the shaft and constructed and arranged to facilitate the flow of soot laden exhaust gas within the clearance and wherein the soot collector may include a nozzle constructed and arranged to facilitate the flow of soot laden exhaust gas to the soot accelerator and the clearance; collecting exhaust gas may include soot via the soot collector; and providing soot within the clearance to lubricate the shaft and the bushing.

Other illustrative variations within the scope of the invention will become apparent from the detailed description provided hereinafter. It should be understood that the detailed description and enumerated variations, while disclosing optional variations, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts one variation of a turbine housing including a wastegate valve including a soot collector and soot accelerator; and

FIG. 2 depicts one variation of a soot collector and soot accelerator.

### DETAILED DESCRIPTION OF ILLUSTRATIVE VARIATIONS

The following description of the variations is merely illustrative in nature and is in no way intended to limit the scope of the invention, its application, or uses. The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and still are considered to be within the scope of the invention.

Diesel combustion engine soot is often laden with graphite which may be used as a natural barrier for preventing mechanical wear between the bushing and the shaft of a wastegate valve within a turbine housing. A soot accelerator and a soot collector may be disposed within a turbine housing and may be constructed and arranged to collect soot and assist in lubricating the wastegate rod (shaft) and bushing to prevent mechanical wear. The collector may act as a nozzle to encourage the flow of soot into a clearance between the shaft and the bushing of the wastegate valve. The accelerator may be an axial slot along the haft that increases the circumferential velocity of the soot, thereby encouraging dispersion. In this way, soot may be continuously supplied and dispersed within the clearance between the shaft and the bushing of the wastegate creating an effective barrier against wear.

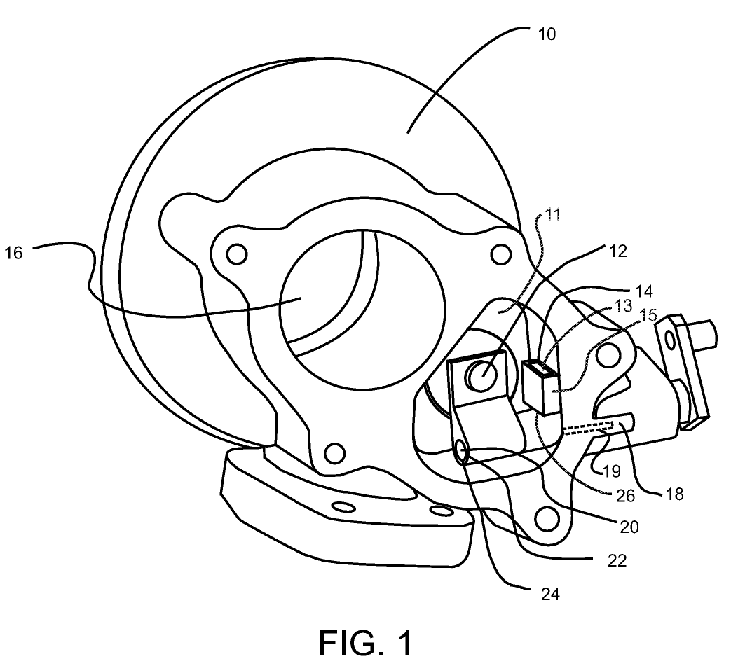

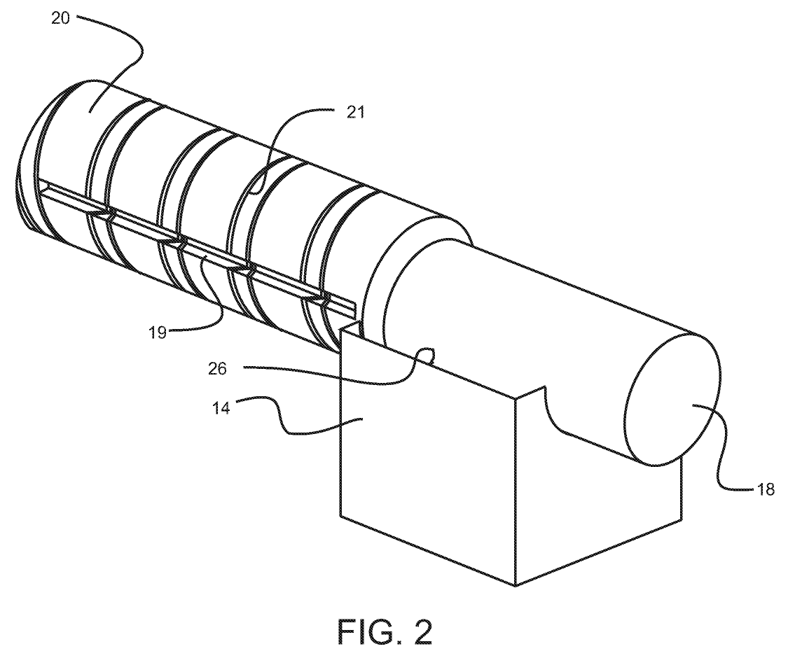

Referring to FIGS. 1 and 2; a turbine housing 10 may include a turbine exit 16 and a wastegate valve 12 including a shaft 20 and bushing 22 with a clearance 24 there between. The turbine housing 10 may also include a soot collector 14 and a soot accelerator 18 constructed and arranged to facilitate collection of soot from the wastegate valve and encouraging flow of soot laden exhaust gas into the clearance 24 between the bushing 22 and the shaft 20. The shaft 20 may include a surface feature 21 such as a plurality of grooves, slots, indents, or dimples thereon constructed and arranged to facilitate the flow of soot laden exhaust gas within the clearance 24. The shaft 20 may rotate such that soot travels the length of the shaft 20 thereby lubricating the wastegate valve 12. Furthermore, the soot accelerator 18 may include an axial slot 19 defined by the turbine housing 10 along the length of the shaft 20. The soot accelerator 18 may include an axial slot 19 defined by a surface of the shaft 20 along the length of the shaft 20. The soot collector 14 may further include a nozzle 26 constructed and arranged to facilitate the flow of soot laden exhaust gas within the clearance 24.

According to variation 1, a product may include a turbine housing that may include a wastegate valve that may include a shaft, a bushing, and a clearance disposed there between; the turbine housing may further include at least one of a soot collector or a soot accelerator constructed and arranged to facilitate the flow of soot laden exhaust gas to the clearance.

Variation 2 may include a product as set forth in variation 1 wherein the shaft may include a surface feature defined on a surface of the shaft and constructed and arranged to facilitate the flow of soot laden exhaust gas within the clearance.

Variation 3 may include a product as set forth in variation 1 or 2 wherein the soot accelerator may include an axial slot defined by the turbine housing along the length of the shaft.

Variation 4 may include a product as set forth in any of variations 1 through 3 wherein the soot accelerator may include an axial slot defined by a surface of the shaft along the length of the shaft.

Variation 5 may include a product as set forth in any of variations 1 through 4 wherein the soot collector may include a nozzle constructed and arranged to facilitate the flow of soot laden exhaust gas to the soot accelerator and the clearance.

According to variation 6, a method may include providing a turbine housing that may include a wastegate valve that may include a shaft, a bushing, and a clearance disposed there between; the turbine housing further may include a soot collector and a soot accelerator constructed and arranged to facilitate the flow of soot laden exhaust gas to the clearance; collecting exhaust gas including soot via the soot collector; and providing soot within the clearance to lubricate the shaft and the bushing.

Variation 7 may include a product as set forth in variation 6 wherein the shaft may include a surface feature defined on a surface of the shaft and constructed and arranged to facilitate the flow of soot laden exhaust gas within the clearance.

Variation 8 may include a product as set forth in any of variations 6 through 7 wherein the soot accelerator may include an axial slot defined by the turbine housing along the length of the shaft.

Variation 9 may include a product as set forth in any of variations 6 through 8 wherein the soot accelerator may include an axial slot defined by a surface of the shaft along the length of the shaft.

Variation 10 may include a product as set forth in any of variations 6 through 9 herein the soot collector may include a nozzle constructed and arranged to facilitate the flow of soot laden exhaust gas to the soot accelerator and the clearance.

According to variation 11, a method may include providing a turbine housing may include a wastegate valve may include a shaft, a bushing, and a clearance disposed there between; the turbine housing furthering may include a soot collector and a soot accelerator constructed and arranged to facilitate the flow of soot laden exhaust gas to the clearance; wherein the shaft may include a surface feature defined on a surface of the shaft and constructed and arranged to facilitate the flow of soot laden exhaust gas within the clearance and wherein the soot collector may include a nozzle constructed and arranged to facilitate the flow of soot laden exhaust gas to the soot accelerator and the clearance; collecting exhaust gas including soot via the soot collector; and providing soot within the clearance to lubricate the shaft and the bushing.

The above description of variations of the invention is merely demonstrative in nature and, thus, variations thereof are not to be regarded as a departure from the spirit and scope of the inventions disclosed within this document.

1. A product comprising:
a turbine housing comprising a wastegate valve comprising a shaft, a bushing, and a clearance disposed there between; the turbine housing further comprising at least one of a soot collector and a soot accelerator constructed and arranged to facilitate flow of a soot laden exhaust gas to the clearance.

2. A product as set forth in claim 1 wherein the shaft comprises a surface feature defined on a surface of the shaft and constructed and arranged to facilitate the flow of soot laden exhaust gas within the clearance.

3. A product as set forth in claim 1 wherein the soot accelerator comprises an axial slot defined by the turbine housing along the length of the shaft.

4. A product as set forth in claim 1 wherein the soot accelerator comprises an axial slot defined by a surface of the shaft along the length of the shaft.

5. A product as set forth in claim 1 wherein the soot collector comprises a nozzle constructed and arranged to facilitate the flow of soot laden exhaust gas to the soot accelerator and the clearance.

6. A method comprising:
providing a turbine housing comprising a wastegate valve comprising a shaft, a bushing, and a clearance disposed there between; the turbine housing further comprising a soot collector and a soot accelerator constructed and arranged to facilitate flow of a soot laden exhaust gas to the clearance;
collecting the soot laden exhaust gas via the soot collector; and
providing the soot laden exhaust gas within the clearance to lubricate the shaft and the bushing.

7. A method as set forth in claim 6 wherein the shaft comprises a surface feature defined on a surface of the shaft and constructed and arranged to facilitate the flow of soot laden exhaust gas within the clearance.

8. A method as set forth in claim 6 wherein the soot accelerator comprises an axial slot defined by the turbine housing along the length of the shaft.

9. A method as set forth in claim 6 wherein the soot accelerator comprises an axial slot defined by a surface of the shaft along the length of the shaft.

10. A method as set forth in claim 6 wherein the soot collector comprises a nozzle constructed and arranged to facilitate the flow of soot laden exhaust gas to the soot accelerator and the clearance.

11. A method comprising:
providing a turbine housing comprising a wastegate valve comprising a shaft, a bushing, and a clearance disposed there between; the turbine housing further comprising a soot collector and a soot accelerator constructed and arranged to facilitate flow of a soot laden exhaust gas to the clearance; wherein the shaft comprises a surface feature defined on a surface of the shaft and constructed and arranged to facilitate flow of the soot laden exhaust gas within the clearance and wherein the soot collector comprises a nozzle constructed and arranged to facilitate flow of the soot laden exhaust gas to the soot accelerator and the clearance;
collecting the soot laden exhaust gas comprising soot via the soot collector; and
providing the soot laden exhaust gas within the clearance to lubricate the shaft and the bushing.
